(19) United States
(12) Patent Application Publication
(10) Pub. No.: US 2020/0040656 A1
(43) Pub. Date: Feb. 6, 2020

(54) Extension Ladder, System and Method

(71) Applicants: Daniel C. Mora, Transfer, PA (US); Kendal King, Greenville, PA (US)

(72) Inventors: Daniel C. Mora, Transfer, PA (US); Kendal King, Greenville, PA (US)

(73) Assignee: Werner Co., Greenville, PA (US)

(21) Appl. No.: 16/053,407

(22) Filed: Aug. 2, 2018

(51) Int. Cl. E06C 1/12; E06C 7/06; E06C 7/08

(52) U.S. Cl. CPC E06C 1/12; E06C 7/08; E06C 7/06

(57) ABSTRACT

An extension ladder having a fly section rested in a base section. A method for positioning an extension ladder. A system for moving extension ladders.

### FIELD OF THE INVENTION

The present invention relates to an extension ladder having a fly section whose rails are nested in rails of a rail section. (As used herein, references to the “present invention” or “invention” relate to exemplary embodiments and not necessarily to every embodiment encompassed by the appended claims.) (As used herein, references to the “present invention” or “invention” relate to exemplary embodiments and not necessarily to every embodiment encompassed by the appended claims.) More specifically, the present invention relates to an extension ladder having a fly section whose rails are nested in rails of a base section where the rails of the base section have stems to position and guide the rails of the fly section as they move relative to the rails of the base section.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Extension ladders provide the convenience of having a base section and a fly section attached to the outside of the base section which moves relative to the base section to extend the effective length of the extension ladder to reach variable heights. The fly section is stacked on the base section, which requires essentially a volume which is the length of the fly section aligned with and on the base section and a width that is the width of the rail of the base section and the width of the rail of the fly section. There may be instances for storage purposes where it is difficult to fit the extension ladder into a place that is out of the way because of its width. Furthermore, when shipping many extension ladders, the number of extension ladders that are placed alongside and on each other is limited by the overall width available to house the ladders together, such as in a cargo area of a truck.

### BRIEF SUMMARY OF THE INVENTION

The present invention pertains to an extension ladder. The ladder comprises a base section having a right base rail and a left base rail in parallel and spaced relation with the right base rail. The right base rail having a C-shaped cross-section formed by a right base flange attached to a base web and a left base flange attached to the base web with the base web disposed between the right base flange and the left base flange. The base section having base rungs attached to the right and left base rails and disposed in front of and outside of the right base flange of the right base rail.

The ladder comprises a fly section having a right fly rail and a left fly rail in parallel and spaced relation with the right fly rail. The fly section having fly rungs attached to and extending in between the right and left fly rails. The right base flange and the left base flange disposed about the right fly rail with the right fly rail disposed in between the right and left base flanges. The fly section nested in the base section and configured for at least a portion of the fly section to slide up above the base section and for the fly section to slide back down relative to the base section while remaining engaged with the base section through the right and left base rails disposed about the right and left fly rails, respectively. The right fly rail formed by a right fly flange attached to a fly web and a left fly flange attached to the fly web with the fly web disposed between the right fly flange and the left fly flange. The right fly rail having a top and a bottom. The top is part of the portion that is configured to slide up above the base section. The ladder comprises a cap attached to the top. The cap having a surface which extends between the right fly flange and the fly web and the left fly flange. The ladder comprises a locking mechanism to fix and lock the fly section to the base section at a desired position relative to the base section.

The present invention pertains to a method of positioning an extension ladder. The method comprises the steps of moving the extension ladder to a desired location. There is the step of sliding a fly section of the extension ladder relative to a base section of the extension ladder to a desired length. There is the step of leaning the extension ladder against an object. The base section having a right base rail and a left base rail in parallel and spaced relation with the right base rail. The right base rail having a C-shaped cross-section formed by a right base flange attached to a base web and a left base flange attached to the base web with the base web disposed between the right base flange and the left base flange. The base section having base rungs attached to the right and left base rails and disposed in front of and outside of the right base flange of the right base rail. The fly section having a right fly rail and a left fly rail in parallel and spaced relation with the right fly rail. The fly section having fly rungs attached to and extending in between the right and left fly rails. The right base flange and the left base flange disposed about the right fly rail with the right fly rail disposed in between the right and left base flanges. The fly section nested in the base section and configured for at least a portion of the fly section to slide up above the base section and for the fly section to slide back down relative to the base section while remaining engaged with the base section through the right and left base rails disposed about the right and left fly rails, respectively. The right fly rail formed by a right fly flange attached to a fly web and a left fly flange attached to the fly web with the fly web disposed between the right fly flange and the left fly flange. The right fly rail having a top and a bottom. The top is part of the portion that is configured to slide up above the base section. The ladder comprises a cap attached to the top. The cap having a surface which extends between the right fly flange and the fly web and the left fly flange. The ladder comprises a locking mechanism to fix and lock the fly section to the base section at a desired position relative to the base section.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a perspective view of an extension ladder of the present invention with the fly section collapsed and nested in and alongside the base section.

FIG. 2 is a perspective view of the extension ladder with the fly section nested in and extended above the base section.

FIG. 3 shows a cross section view through the J-locks.

FIGS. 4A and 4B show details of how the rungs are attached to the fly and base sections, respectively.

FIG. 5 shows a perspective view of an upper end of the extension ladder with a fly rail having a rectangular cross-section nested in a base rail with J-locks.

FIG. 6 shows an overhead view of the extension ladder with a fly rail having a rectangular cross-section nested in a base rail with J-locks.

FIG. 7 shows a perspective view of an upper end of the extension ladder with a fly rail having a rectangular cross-section nested in a base rail with swing locks.

FIG. 8 shows an overhead view of the extension ladder with a fly rail having a rectangular cross-section nested in a base rail with swing locks.

FIG. 9 shows a perspective view of an upper end of the extension ladder with a fly rail having a C-shaped cross-section nested in a base rail with J-locks.

FIG. 10 shows an overhead view of the extension ladder with a fly rail having a C-shaped cross-section nested in a base rail with J-locks.

FIG. 11 shows a perspective view of an upper end of the extension ladder with a fly rail having a C-shaped cross-section nested in a base rail with swing locks.

FIG. 12 shows an overhead view of the extension ladder with a fly rail having a C-shaped cross-section nested in a base rail with swing locks.

FIG. 13 shows a C-shaped cross-section of a base rail over a rectangular or box shaped cross-section of a fly rail with J-locks.

FIG. 14 shows a C-shaped cross-section of a base rail over a rectangular or box cross-section of a fly rail with swing locks.

FIG. 15 shows a C-shaped cross-section of a base rail over a C-shaped cross-section of a fly rail with J-locks.

FIG. 16 shows a C-shaped cross-section of a base rail over a C-shaped cross-section of a fly rail with swing locks.

FIG. 17A is an overhead perspective view of a cap.

FIG. 17B is an underside perspective view of a cap.

FIG. 18 is an overhead view of the extension ladder at maximum extension.

FIG. 19 is a side view of the extension ladder at maximum extension.

FIG. 20 shows a typical base rail profile.

FIG. 21 shows a typical profile of C-shaped fly rail.

FIG. 22 shows a typical profile of a rectangular shaped fly rail.

FIG. 23 is a side view of three extension ladders stacked on top of each other.

FIG. 24 is an overhead view of three extension ladders stacked on top of each other.

### DETAILED DESCRIPTION OF THE INVENTION

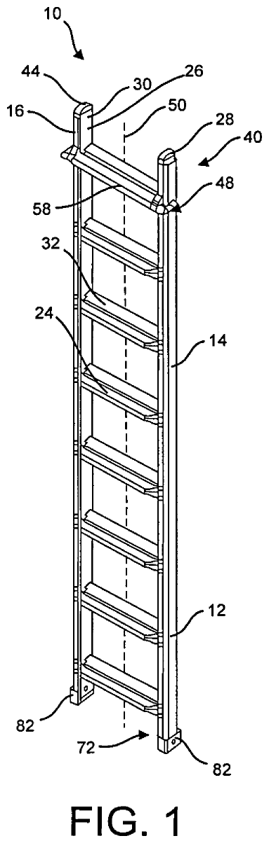

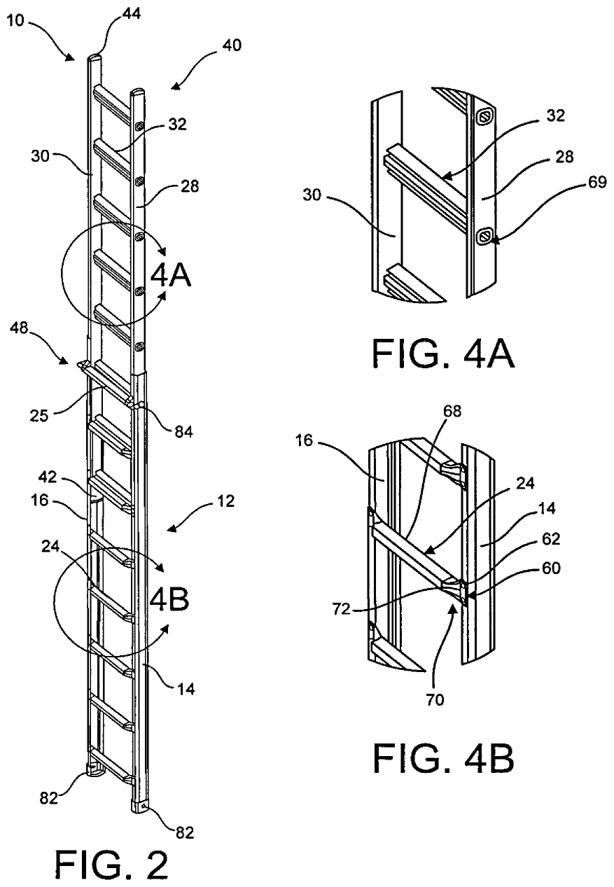

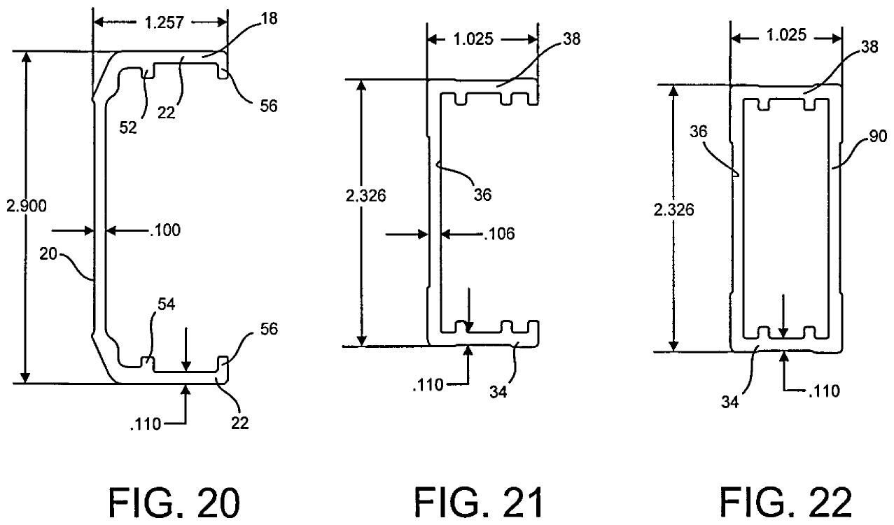

Referring now to the drawings wherein like reference numerals refer to similar or identical parts throughout the several views, and more specifically to FIGS. 1 and 2 thereof, there is shown an extension ladder 10. The ladder 10 comprises a base section 12 having a right base rail 14 and a left base rail 16 in parallel and spaced relation with the right base rail 14. The right base rail 14 having a C-shaped cross-section formed by a right base flange 18 attached to a base web 20 and a left base flange 22 attached to the base web 20 with the base web 20 disposed between the right base flange 18 and the left base flange 22, as shown in FIG. 20. The base section 12 having base rungs 24 attached to the right and left base rails 14, 16 and disposed in front of and outside of the right base flange 18 of the right base rail 14.

The ladder 10 comprises a fly section 26 having a right fly rail 28 and a left fly rail 30 in parallel and spaced relation with the right fly rail 28. The fly section 26 having fly rungs 32 attached to and extending in between the right and left fly rails 28, 30. The right base flange 18 and the left base flange 22 disposed about the right fly rail 28 with the right fly rail 28 disposed in between the right and left base flanges 18, 22. The fly section 26 nested in the base section 12 and configured for at least a portion of the fly section 26 to slide up above the base section 12 and for the fly section 26 to slide back down relative to the base section 12 while remaining engaged with the base section 12 through the right and left base rails 14, 16 disposed about the right and left fly rails 28, 30, respectively. The right fly rail 28 formed by a right fly flange 34 attached to a fly web 36 and a left fly flange 38 attached to the fly web 36 with the fly web 36 disposed between the right fly flange 34 and the left fly flange 38, as shown in FIGS. 21 and 22. The right fly rail 28 having a top 40 and a bottom 42. The top 40 is part of the portion that is configured to slide up above the base section 12. The base rails and the fly rails may be made of aluminum or fiberglass. Preferably, the base rails and the fly rails or straight.

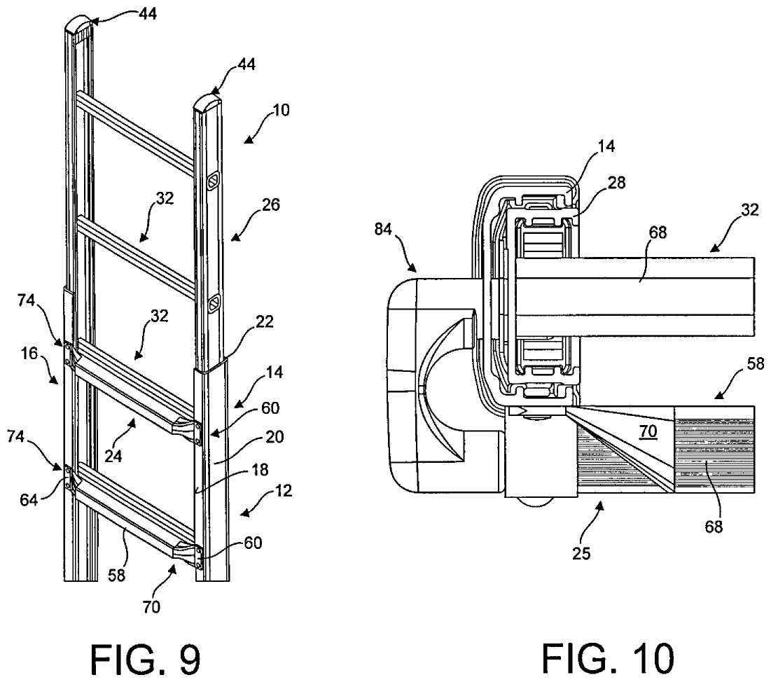

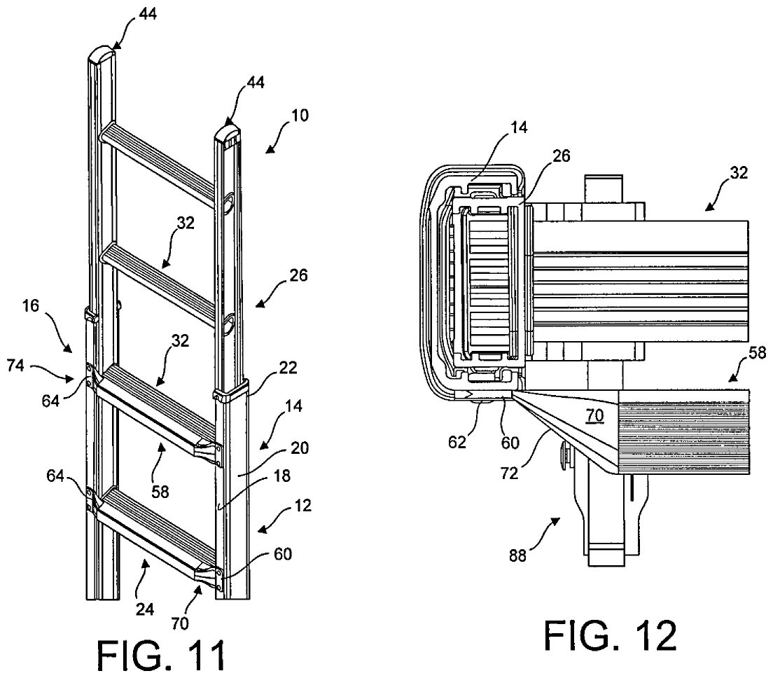

The fly section 26 may be nested in at least two ways. In one way, the fly web 36 is adjacent and alongside the base web 20 when the right fly flange 34 and left fly flange 38 extend outward from the fly web 36 away from the center line 50 of the extension ladder 10, as shown in FIGS. 11 and 12. In another way, the fly web 36 is spaced apart from the base web 20 when the right fly flange 34 and left fly flange 38 extend inward from the fly web 36 toward the center line 50 of the extension ladder 10, as shown in FIGS. 9 and 10.

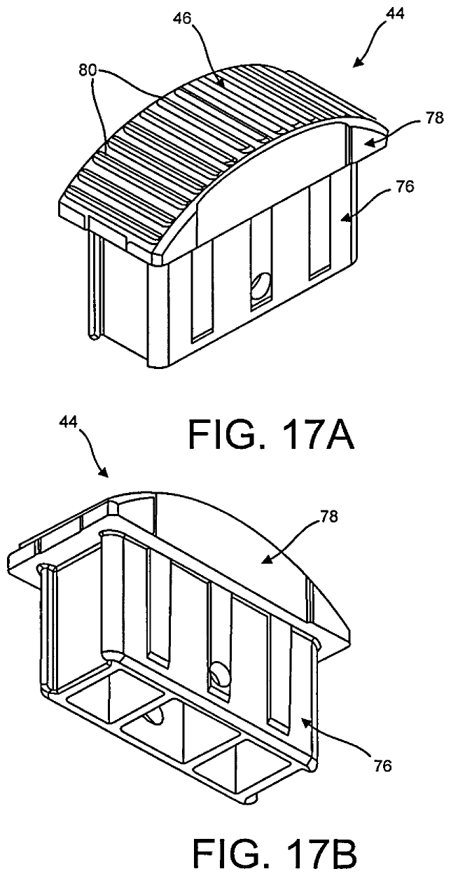

The ladder 10 comprises a cap 44, as shown in FIG. 17A and 17B, attached to the top 40 with no object attached to the cap 44 above the cap 44. The cap 44 having a surface 46 which extends between the right fly flange 34 and the fly web 36 and the left fly flange 38. The ladder 10 comprises a locking mechanism 48 to fix and lock the fly section 26 to the base section 12 at a desired position relative to the base section 12. The extension ladder 10 can support at least 300 lbs. and has a duty rating of at least 1A.

The right base rail 14 may have a right stem 52 extending inwards from the right base flange 18 toward the left base flange 22, and has a left stem 54 extending inwards from the left base flange 22 toward the right base flange 18, as shown in FIGS. 6, 8, 10, 12 and 20. The right and left stems 52, 54 position the right fly rail 28 in between the right and left rail base flanges a desired distance and act as guides for the right fly rail 28 as the right fly rail 28 moves relative to the right base rail 14, and to position the right fly rail 34 away from rivet upsets. The stems additionally serve to strengthen the right base rail 14 and add buttressing and stiffness to the right base rail 14. The stems extend along the length of the right base rail 14. There may be additional stems 56, such as one additional stem 56 in spaced relation and in parallel with the right stem 52 and also with the left stem 54 to further act as guides for the right fly rail 28 as the right fly rail 28 moves relative to the right base rail 14. The stems serve to tighten the tolerances between the right fly rail 28 and right base rail 14. The left base rail 16 may have stems, same as the right base rail 14 for the same purpose and function. The stems may be between 0.1 and 0.2 inches long and about 0.1 inches wide.

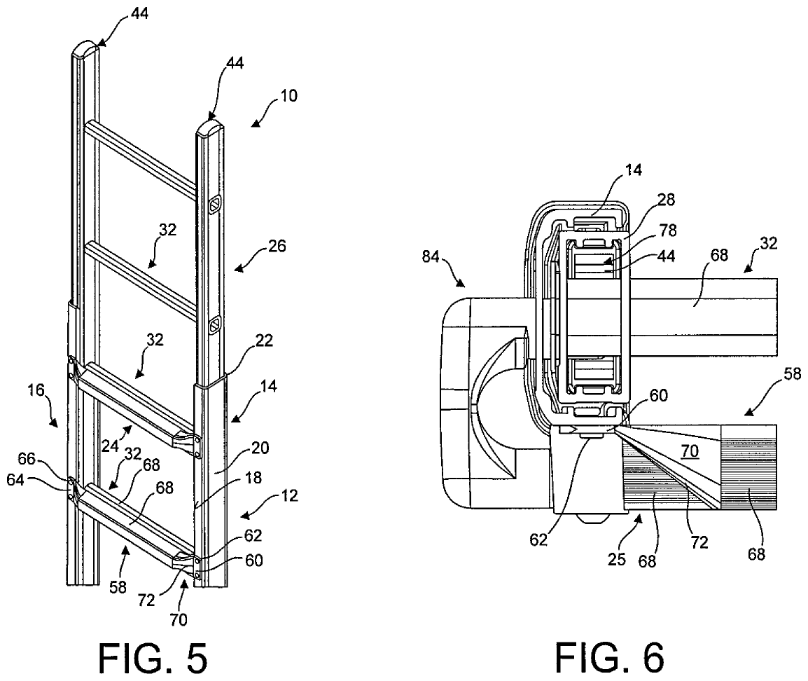

A first base rung 58 of the base rungs 24 may have a first flattened end 60 that conforms with and fits against and contacts and is in parallel with the right base flange 18 of the right base rail 14, as shown in FIGS. 5, 7, 9 and 11. The base section 12 may have at least a first fastener 62, such as a rivet, which extends through the first flattened end 60 and the right base flange 18 to fasten the first flattened end 60 to the right base flange 18. The first base rung 58 may have a second flattened end 64 that is fastened to the left base rail 16 with a second fastener 66. The first base rung 58 may have a step portion 68 which is flat and extends between the first and second flattened ends 60, 64. The flat step portion 68 may be essentially perpendicularly oriented to the first and second flattened ends 60, 64. The first base rung 58 may have a first tapered portion 70 which has a slope 72 that extends inwards between the step portion 68 and the first flattened end 60, and may have a second tapered portion 74 which has a slope 72 that extends inwards between the step portion 68 and the second flattened end 64. The flattened ends and their tapered portions are formed by crimping, with the tapered portions having a slope 72 of between 20 degrees and 65 degrees and preferably about 45 degrees. In this way the slope 72 is not so severe that tears or cracks in the crimped or tapered portions are created in the crimping process. The tapered portion begins about 1.5 inches to about 3 inches from the inner edge of the right base flange 18, and the same for the left side of the rung.

The fly rungs 32 may be swaged to the fly webs 36 of the first and second fly rails and form a swage joint 69, as shown in FIG. 4A. The rungs may be hollow and have a step portion 68 which has grooves or serrations to provide for traction when a user places a foot on the stepping surface 46 of a fly rung.

The cap 44 may have an attachment portion 76 that is disposed between and extends along the fly web 36 and the right fly flange 34 and the left fly flange 38, and a ceiling portion 78 attached to and extending from and above the attachment portion 76, as shown in FIGS. 17A and 17B. The ceiling portion 78 having a solid surface 46 and a perimeter that defines a ridge that extends along and on the top 40 of the right fly rail 28 in contact and on the fly web 36 and the right fly flange 34 and the left fly flange 38. The ceiling portion 78 may extend upward in an arc shape. The ceiling portion 78 may have ribs 80 disposed on the solid surface 46. There are no additional sections of the ladder 10 extending above from the fly section 26 or from the caps 44, and there are no hinges attached to the fly section 26 ladder 10 extending above the fly section 26. The bottom 42 of each base rail upon which the extension ladder 10 rests on ground when the extension ladder 10 is leaning against an object either is the bare rail itself or has a foot 82 on the bottom 42.

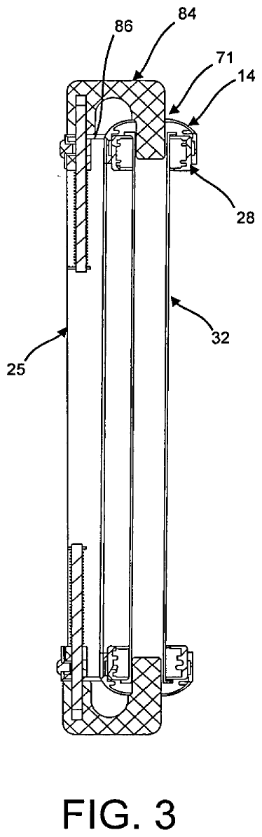

The locking mechanism 48 may be a J-lock 84 that extends from a side of a J-lock rung 25 of the base section 12 and back through a lock hole 71 in the right base rail 14 and into a rung 32 of the fly section 26 through an end of the rung, which is hollow, to lock the fly section 26 and the base section 12 together, as shown in FIG. 3. The fly section 26 and the base section 12 are configured to be in a locked position so their rungs are alongside each other, so the portions of the fly section 26 and base section 12 which overlap have their steps in line so the foot of a user fits on and steps on the rung of the base section 12 and with the aligned adjacent rung of the fly section 26. The fly section 26 is configured to slide relative to the base section 12 when the J-lock 84 is pulled out from the rung of the fly section 26. The J-lock rung 25 from which the J-lock 84 extends may have a squared or flat face 86 instead of a crimped end. The J-lock 84 fits in and extends from the flat face 86, as shown in FIGS. 3, 13 and 15. Alternately, the locking mechanism 48 may be a swing lock 88 that is attached to the right fly flange 34 and the left fly flange 38 of the right base rail 14 and which encompasses a rung of the base section 12 and an adjoining rung of the fly section 26 at a desired position of the fly section 26 relative to the base section 12, as shown in FIGS. 14 and 16.

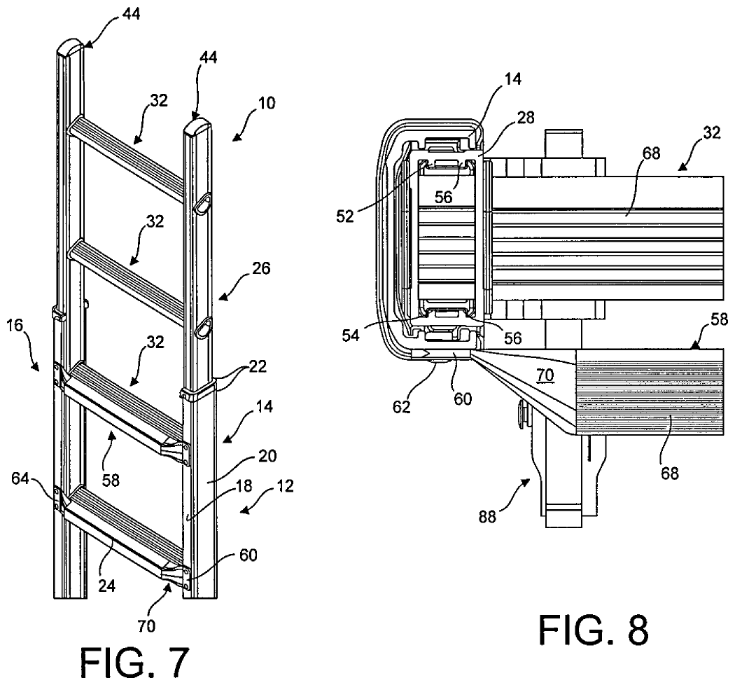

The right fly rail 28 may have a wall 90 attached to the right fly flange 34 and the left fly flange 38 and extending between the right fly flange 34 and the left fly flange 38 and in parallel and spaced relation to the fly web 36, as shown in FIGS. 5-8. The fly web 36 and the wall 90 and the right and left fly flanges 34, 38 forming a cross sectional shape of a rectangle with the wall 90 closing the C cross-section. This is another way the fly section 26 may be nested within the base section 12, where the right fly rail 28 is nested in the right base rail 14. FIGS. 5 and 6 show this embodiment with J-locks 84, where the fly rungs 32 have a hollow rectangular cross-section which corresponds to the cross-section of the J lock that fits into the fly rung. FIGS. 7 and 8 show this embodiment with swing locks 88, where the fly rungs 32 have a D-shaped cross-section, with the step portion 68 of the fly rung having a slight angle downwards to better receive a foot of a user when the user places a foot on the fly rung.

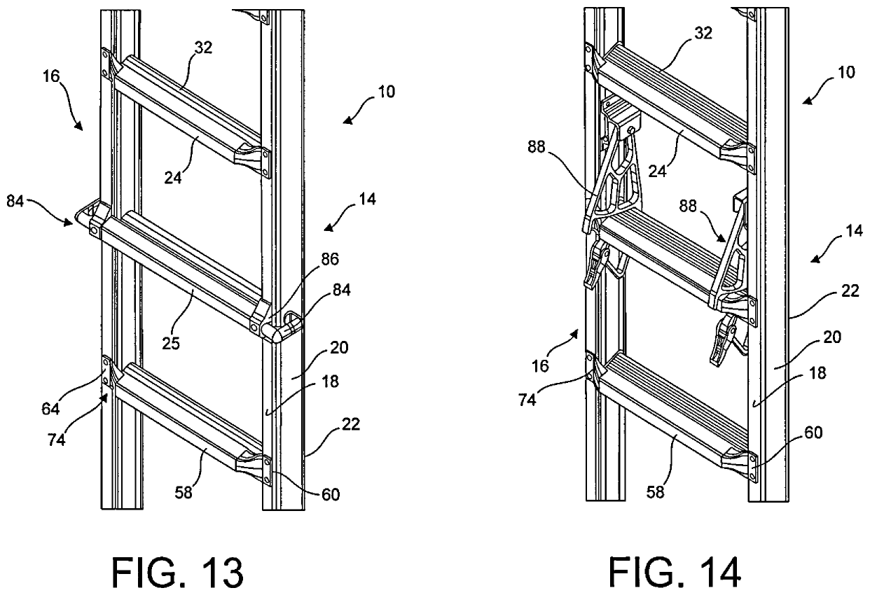

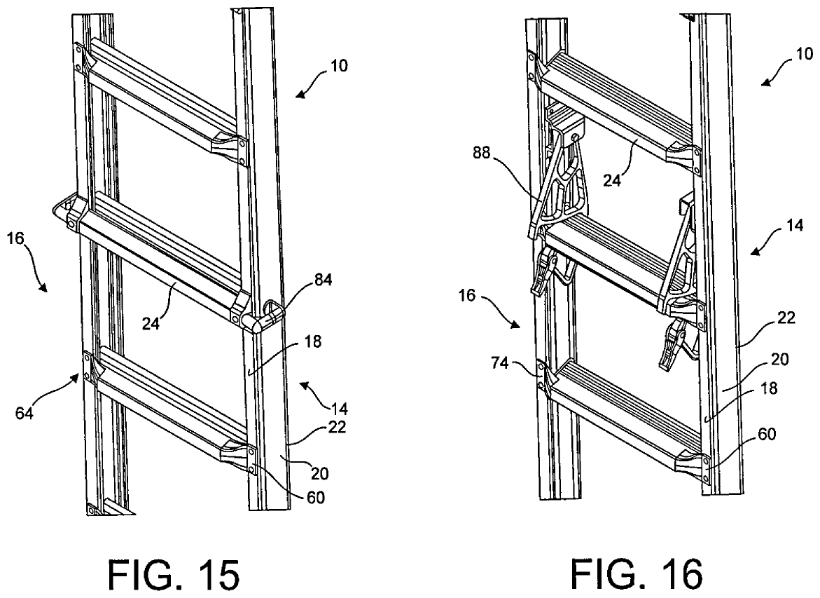

FIG. 13 shows a C-shaped cross-section of a base rail over a rectangular or box shaped cross-section of a fly rail with J-locks 84. FIG. 14 shows a C-shaped cross-section of a base rail over a rectangular or box cross-section of a fly rail with swing locks 88. FIG. 15 shows a C-shaped cross-section of a base rail over a C-shaped cross-section of a fly rail with J-locks 84. FIG. 16 shows a C-shaped cross-section of a base rail over a C-shaped cross-section of a fly rail with swing locks 88.

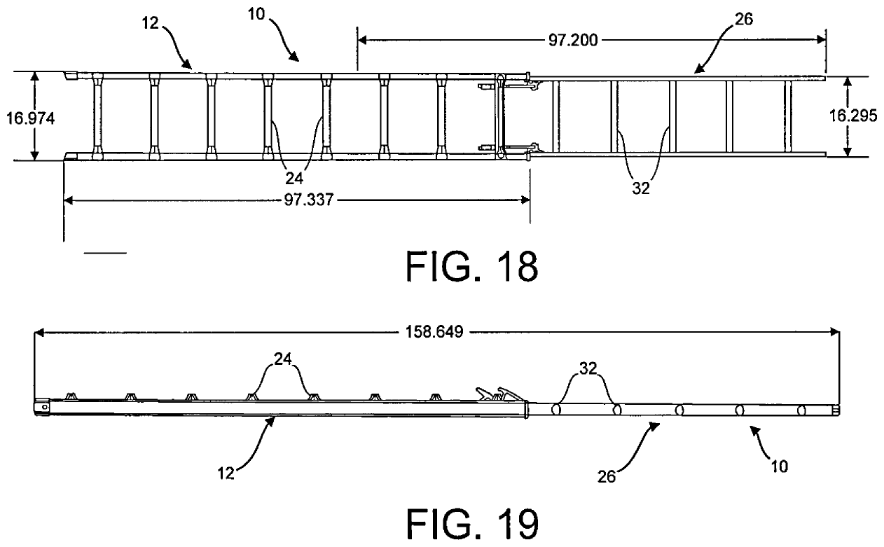

FIG. 18 is an overhead view of the extension ladder 10 at maximum extension. FIG. 19 is a side view of the extension ladder 10 at maximum extension.

FIG. 20 shows a typical base rail profile. FIG. 21 shows a typical profile of C-shaped fly rail. FIG. 22 shows a typical profile of a rectangular shaped fly rail.

The present invention pertains to a method of positioning an extension ladder 10. The method comprises the steps of moving the extension ladder 10 to a desired location. There is the step of sliding a fly section 26 of the extension ladder 10 relative to a base section 12 of the extension ladder 10 to a desired length. There is the step of leaning the extension ladder 10 against an object. The base section 12 having a right base rail 14 and a left base rail 16 in parallel and spaced relation with the right base rail 14. The right base rail 14 having a C-shaped cross-section formed by a right base flange 18 attached to a base web 20 and a left base flange 22 attached to the base web 20 with the base web 20 disposed between the right base flange 18 and the left base flange 22. The base section 12 having base rungs 24 attached to the right and left base rails 14, 16 and disposed in front of and outside of the right base flange 18 of the right base rail 14. The fly section 26 having a right fly rail 28 and a left fly rail 30 in parallel and spaced relation with the right fly rail 28. The fly section 26 having fly rungs 32 attached to and extending in between the right and left fly rails 28, 30. The right base flange 18 and the left base flange 22 disposed about the right fly rail 28 with the right fly rail 28 disposed in between the right and left base flanges 18, 22. The fly section 26 nested in the base section 12 and configured for at least a portion of the fly section 26 to slide up above the base section 12 and for the fly section 26 to slide back down relative to the base section 12 while remaining engaged with the base section 12 through the right and left base rails 14, 16 disposed about the right and left fly rails 28, 30, respectively. The right fly rail 28 formed by a right fly flange 34 attached to a fly web 36 and a left fly flange 38 attached to the fly web 36 with the fly web 36 disposed between the right fly flange 34 and the left fly flange 38. The right fly rail 28 having a top 40 and a bottom 42. The top 40 is part of the portion that is configured to slide up above the base section 12. The ladder 10 comprises a cap 44 attached to the top 40 with no object attached above the cap 44. The cap 44 having a surface 46 which extends between the right fly flange 34 and the fly web 36 and the left fly flange 38. The ladder 10 comprises a locking mechanism 48 to fix and lock the fly section 26 to the base section 12 at a desired position relative to the base section 12.

By the extension ladder 10 with the fly section 26 rails nested inside the base section 12 C-channel rails, the front to rear dimension of the ladder 10 is reduced. The fly section 26 has a standard rung design which gives a wide, comfortable standing surface 46 when climbing at height. The base section 12 has rungs with flattened ends which are riveted to the outside of the front flange of the rail. This construction allows the fly to move freely within the base section 12 as the fly is extended or retracted. The fly and base sections 12 can be held in position relative to each other by the use of J-locks 84, the use of conventional extension ladder rung locks, or other latching mechanisms.

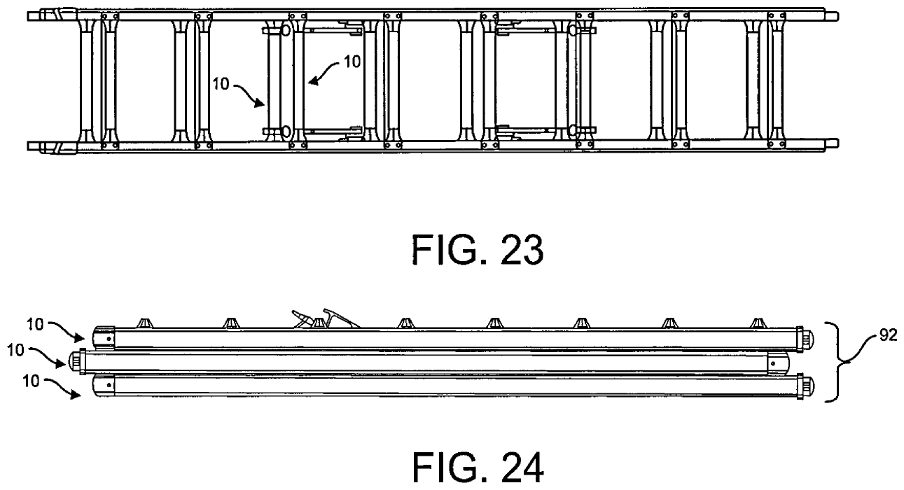

Conventional extension ladders have the rail sections stacked on top of each other. The height of the extension ladders stacked on top of each other is defined as a stack height. The smaller stack height 92 of extension ladders 10 stacked on top of each other, as shown in FIGS. 23 and 24, permits a higher product density in palletization and containerization which will reduce shipping cost. For instance, when shipping, a first extension ladder having a second extension ladder placed on top of the first extension ladder or alongside the first extension ladder has a stack height 92 ⅓ less than the stack height of a first conventional extension ladder having a second conventional extension ladder placed on top of the first conventional extension ladder or alongside the first extension ladder, where the conventional extension ladder has the fly section 26 alongside the base section 12 but not nested in the base section 12. For instance, with two conventional extension ladders stacked on each other, the stack height would be the height of at least the width of four rails, the width of the base and fly rails of a first conventional extension ladder plus the width of the base and fly rails of the second conventional ladder on top of the first conventional ladder. With two extension ladders 10, the stack height is about the width of the base rail 14 of the first extension ladder 10 plus the width of the base rail 14 of the second extension ladder 10 on top of the first extension ladder 10.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. An extension ladder comprising:
a base section having a right base rail and a left base rail in parallel and spaced relation with the right base rail, the right base rail having a C-shaped cross-section formed by a right base flange attached to a base web and a left base flange attached to the base web with the base web disposed between the right base flange and the left base flange, the base section having base rungs attached to the right and left base rails and disposed in front of and outside of the right base flange of the right base rail;
a fly section having a right fly rail and a left fly rail in parallel and spaced relation with the right fly rail, the fly section having fly rungs attached to and extending in between the right and left fly rails, the right base flange and the left base flange disposed about the right fly rail with the right fly rail disposed in between the right and left base flanges, the fly section nested in the base section and configured for at least a portion of the fly section to slide up above the base section and for the fly section to slide back down relative to the base section while remaining engaged with the base section through the right and left base rails disposed about the right and left fly rails, respectively, the right fly rail formed by a right fly flange attached to a fly web and a left fly flange attached to the fly web with the fly web disposed between the right fly flange and the left fly flange, the right fly rail having a top and a bottom, the top is part of the portion that is configured to slide up above the base section;
a cap attached to the top, the cap having a surface which extends between the right fly flange and the fly web and the left fly flange; and
a locking mechanism to fix and lock the fly section to the base section at a desired position relative to the base section.

2. The ladder of claim 1 wherein the right base rail has a right stem extending inwards from the right base flange toward the left base flange, and has a left stem extending inwards from the left base flange toward the right base flange, the right and left stems position the right fly rail in between the right and left rail flanges a desired distance and act as guides for the right fly rail as the right fly rail moves relative to the right base rail, and to position the right fly rail away from rivet upsets.

3. The ladder of claim 2 wherein a first base rung of the base rungs has a first flattened end that conforms with and fits against and contacts and is in parallel with the right base flange of the right base rail, at least a first fastener extends through the first flattened end and the right base flange to fasten the first flattened end to the right base flange, the first base rung has a second flattened end that is fastened to the left base rail with a second fastener, the first base rung has a step portion which is flat and extends between the first and second flattened ends, the flat step portion is essentially perpendicularly oriented to the first and second flattened ends.

4. The ladder of claim 3 wherein the first base rung has a first tapered portion which has a slope that extends inwards between the step portion and the first flattened end, and has a second tapered portion which has a slope that extends inwards between the step portion and the second flattened end.

5. The ladder of claim 4 wherein the cap has an attachment portion that is disposed between and extends along the fly web and the right fly flange and the left fly flange, and a ceiling portion attached to and extending from and above the attachment portion, the ceiling portion having a solid surface and a perimeter that defines a ridge that extends along and on the top of the right fly rail in contact and on the fly web and the right fly flange and the left fly flange.

6. The ladder of claim 5 where the ceiling portion extends upward in an arc shape.

7. The ladder of claim 6 wherein the ceiling portion has ribs disposed on the solid surface.

8. The ladder of claim 7 wherein the locking mechanism is either a J-lock that extends from a side of a rung of the base section and back through a lock hole in the right base rail and into a rung of the fly section to lock the fly section and the base section together, the fly section configured to slide relative to the base section when the J-lock is pulled out from the rung of the fly section; or a swing lock that is attached to the right fly flange and the left fly flange of the right base rail and which encompasses a rung of the base section and an adjoining rung of the fly section at a desired position of the fly section relative to the base section.

9. The ladder of claim 8 wherein the right fly rail has a wall attached to the right fly flange and the left fly flange and extending between the right fly flange and the left fly flange and in parallel and spaced relation to the fly web, the fly web and the wall and the right and left fly flanges forming a cross sectional shape of a rectangle.

10. The ladder of claim 9 including a second extension ladder having a fly section nested in a base section, the second extension ladder stacked on the extension ladder and having a stack height that is at least ⅓ less than a stack height of a first extension ladder having a fly section on top of a base section stacked on a second extension ladder having a fly section on top of a base section.

11. A method of positioning an extension ladder comprising the steps of:
moving the extension ladder to a desired location;
sliding a fly section of the extension ladder relative to a base section of the extension ladder to a desired length; and
leaning the extension ladder against an object, the base section having a right base rail and a left base rail in parallel and spaced relation with the right base rail, the right base rail having a C-shaped cross-section formed by a right base flange attached to a base web and a left base flange attached to the base web with the base web disposed between the right base flange and the left base flange, the base section having base rungs attached to the right and left base rails and disposed in front of and outside of the right base flange of the right base rail; the fly section having a right fly rail and a left fly rail in parallel and spaced relation with the right fly rail, the fly section having fly rungs 32 attached to and extending in between the right and left fly rails, the right base flange and the left base flange disposed about the right fly rail with the right fly rail disposed in between the right and left base flanges, the fly section nested in the base section and configured for at least a portion of the fly section to slide up above the base section and for the fly section to slide back down relative to the base section while remaining engaged with the base section through the right and left base rails disposed about the right and left fly rails, respectively, the right fly rail formed by a right fly flange attached to a fly web and a left fly flange attached to the fly web with the fly web disposed between the right fly flange and the left fly flange, the right fly rail having a top and a bottom, the top is part of the portion that is configured to slide up above the base section; the extension ladder having a cap attached to the top, the cap having a surface which extends between the right fly flange and the fly web and the left fly flange; and the extension ladder having a locking mechanism to fix and lock the fly section to the base section at a desired position relative to the base section.

12. The method of claim 11 wherein the right base rail has a right stem extending inwards from the right base flange toward the left base flange, and has a left stem extending inwards from the left base flange toward the right base flange, the right and left stems position the right fly rail in between the right and left rail flanges a desired distance and act as guides for the right fly rail as the right fly rail moves relative to the right base rail, and to position the right fly rail away from rivet upsets.

13. The method of claim 12 wherein a first base rung of the base rungs has a first flattened end that conforms with and fits against and contacts and is in parallel with the right base flange of the right base rail, at least a first fastener extends through the first flattened end and the right base flange to fasten the first flattened end to the right base flange, the first base rung has a second flattened end that is fastened to the left base rail with a second fastener, the first base rung has a step portion which is flat and extends between the first and second flattened ends, the flat step portion is essentially perpendicularly oriented to the first and second flattened ends.

14. The method of claim 13 wherein the first base rung has a first tapered portion which has a slope that extends inwards between the step portion and the first flattened end and has a second tapered portion which has a slope that extends inwards between the step portion and the second flattened end.

15. The method of claim 14 wherein the cap has an attachment portion that is disposed between and extends along the fly web and the right fly flange and the left fly flange, and a ceiling portion attached to and extending from and above the attachment portion, the ceiling portion having a solid surface and a perimeter that defines a ridge that extends along and on the top of the right fly rail in contact and on the fly web and the right fly flange and the left fly flange.

16. The method of claim 15 where the ceiling portion extends upward in an arc shape.

17. The method of claim 16 wherein the ceiling portion has ribs disposed on the solid surface.

18. The method of claim 17 wherein the locking mechanism is either a J-lock that extends from a side of a rung of the base section and back through a lock hole in the right base rail and into a rung of the fly section to lock the fly section and the base section together, the fly section configured to slide relative to the base section when the J-lock is pulled out from the rung of the fly section; or a swing lock that is attached to the right fly flange and the left fly flange of the right base rail and which encompasses a rung of the base section and an adjoining rung of the fly section at a desired position of the fly section relative to the base section.

19. The method of claim 18 wherein the right fly rail has a wall attached to the right fly flange and the left fly flange and extending between the right fly flange and the left fly flange and in parallel and spaced relation to the fly web, the fly web and the wall and the right and left fly flanges forming a cross-sectional shape of a rectangle.

20. A system for moving extension ladders comprising a first extension ladder having a fly section nested in a base section and a second extension ladder having a fly section nested in a base section, the second extension ladder stacked on the extension ladder and having a stack height that is at least ⅓ less than a stack height of a first extension ladder having a fly section on top of a base section stacked on a second extension ladder having a fly section on top of a base section.
